(19) United States
(12) Patent Application Publication
(10) Pub. No.: US 2005/0071247 A1
(43) Pub. Date: Mar. 31, 2005

(54) Integrated transportation method and system

(76) Inventors: Karin Kelley, North Field, OH (US); Jason Bartholomew, Mayfield Heights, OH (US); Ramanand Lanka, Mayfield Heights, OH (US); Brian Barile, Solon, OH (US); Wilton E. Foster, Hudson, OH (US)

Correspondence Address: RATNERPRESTIA, P O BOX 980, VALLEY FORGE, PA, 19482-0980, US

(21) Appl. No.: 10/943,765

(22) Filed: Sep. 17, 2004

Related U.S. Application Data
(60) Provisional application No. 60/506,366, filed on Sep. 26, 2003.

(51) Int. Cl. G06F 17/60

(52) U.S. Cl. 705/26

(57) ABSTRACT

An integrated transportation management method, system, and apparatus for use between one or more shippers and a plurality of carriers is disclosed. The method includes receiving load information corresponding to a load from a shipper through an electronic interface, tendering the load to one or more carriers over a global information network based on automated business rules, assigning the tendered load to one of the one or more carriers, notifying the shipper of the assigned carrier for the tendered load through the electronic interface, receiving an electronic delivery confirmation signal corresponding to the tendered load, authorizing payment to the carrier responsive to the electronic delivery confirmation signal, and receiving payment information corresponding to the authorized payment.

### FIELD OF THE INVENTION

The present invention relates to the commercial transportation industry and, more particularly, to a system and apparatus for use between at least one shipper and one or more carriers to manage transactions relating to the transportation of goods.

### BACKGROUND OF THE INVENTION

Manufacturers, recycling centers, warehouse owners, and other such entities (referred to herein as “shippers”) routinely need to transport goods from one point, the origin, to another point, the destination. Many of these entities look to third party commercial transportation companies (referred to herein as “carriers”) to transport their goods. These carriers, which specialize in the delivery of goods, often provide a more economical solution for the transportation of goods than if the shipper itself were to hire employees and maintain a fleet of vehicles to transport the goods. In the transportation industry, the shipment of goods is typically performed using trucks, with the goods for delivery by a single truck referred to as a load.

Shippers typically have a shipping department and/or purchasing department for managing the loads. These departments perform numerous tasks, including assigning shipments to carriers, authorizing payment to carriers for the delivery of goods, and monitoring internal shipping requirements. Often these tasks are done with disparate systems. For example, assignment of the goods to a carrier may be done manually by employees via telephone or facsimile, payments may be made or authorized using a payment computer system, and internal shipping requirements may be made using an internal shipment computer system that is separate from the payment computer system. In addition, manual systems may be employed to transfer information amongst the various systems and employees. Many times, there are not clear specifications for carrying out the manual tasks, or the specifications are not readily available/known, leaving it to the discretion of the employee.

The manual systems used to perform certain transactions and necessitated by the use of disparate systems creates inefficiencies in the shipment process. These inefficiencies lead to higher shipping related cost, which affects adversely the profitability of the shipper. Additionally, breakdowns in the manual systems may strain relationships between the shipper and the carriers. For example, a carrier may be upset if the carrier delivered a load, but was not paid due to a breakdown in communication with the payment system. Strained relationships with the carriers may reduce the pool of carriers willing to work with the shipper, which negatively affects the shipper's ability to have goods transported in a timely, cost effective manner.

Accordingly, improved methods, systems, and apparatus are needed for use between shippers and carriers to manage transportation transactions that are not subject to the above limitations. The present invention satisfies this need among others.

### SUMMARY OF THE INVENTION

The present invention includes an integrated transportation management method, system, and apparatus for use between one or more shippers and a plurality of carriers. The method includes receiving load information corresponding to a load from a shipper through an electronic interface, tendering the load to one or more carriers over a global information network based on automated business rules, assigning the tendered load to one of the one or more carriers, notifying the shipper of the assigned carrier for the tendered load through the electronic interface, receiving an electronic delivery confirmation signal corresponding to the tendered load, authorizing payment to the carrier responsive to the electronic delivery confirmation signal corresponding to the tendered load, and receiving payment information corresponding to the authorized payment. One or more of the method steps may be implemented in software for controlling one or more general purpose computers.

The system includes means for receiving load information corresponding to a load from a shipper through an electronic interface; means for tendering the load to one or more carriers over a global information network using automated business rules, means for assigning one of the one or more carriers to the tendered load, means for notifying the shipper of the assigned carrier for the tendered load through the electronic interface, means for receiving an electronic delivery confirmation signal corresponding to the tendered load from the assigned carrier, means for authorizing payment to the assigned carrier responsive to the electronic delivery confirmation signal, and means for receiving payment information corresponding to the authorized payment.

The apparatus includes a rate server including rate information for each of the plurality of carriers; an integration server coupled to the rate server and in communication with the one or more shippers, the integration server configured to integrate load information for a load received from the one or more shippers and rate information received from the rate server to generate load tender information for the load according to automated business rules; a transportation database accessible by the integration server and the plurality of carriers, the transportation database configured to receive and store the load tendering information from the integration server for tendering the load to one or more of the plurality of carriers according to the automated business rules; and a financial server coupled to the integration server, the financial server configured to authorize a financial institution to pay one of the plurality of carriers upon confirmation of delivery of the load.

### BRIEF DESCRIPTION OF THE DRAWINGS

The present invention is best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be dropped. The letter “n” may represent a non-specific number of elements. Included in the drawings are the following figures:

FIG. 1 is a block diagram of a transportation system in accordance with the present invention;

FIG. 2 is a block diagram of an exemplary transportation management system for use in the transportation system of FIG. 1;

FIG. 3 is a flow chart depicting an exemplary transportation management method in accordance with the present invention;

FIG. 4 is a screen display of a graphical user interface for specifying business rules in accordance with one aspect of the present invention; and

FIG. 5 is a screen display of a graphical user interface for presenting tendered loads to a carrier for acceptance in accordance with the present invention.

### DETAILED DESCRIPTION OF THE INVENTION

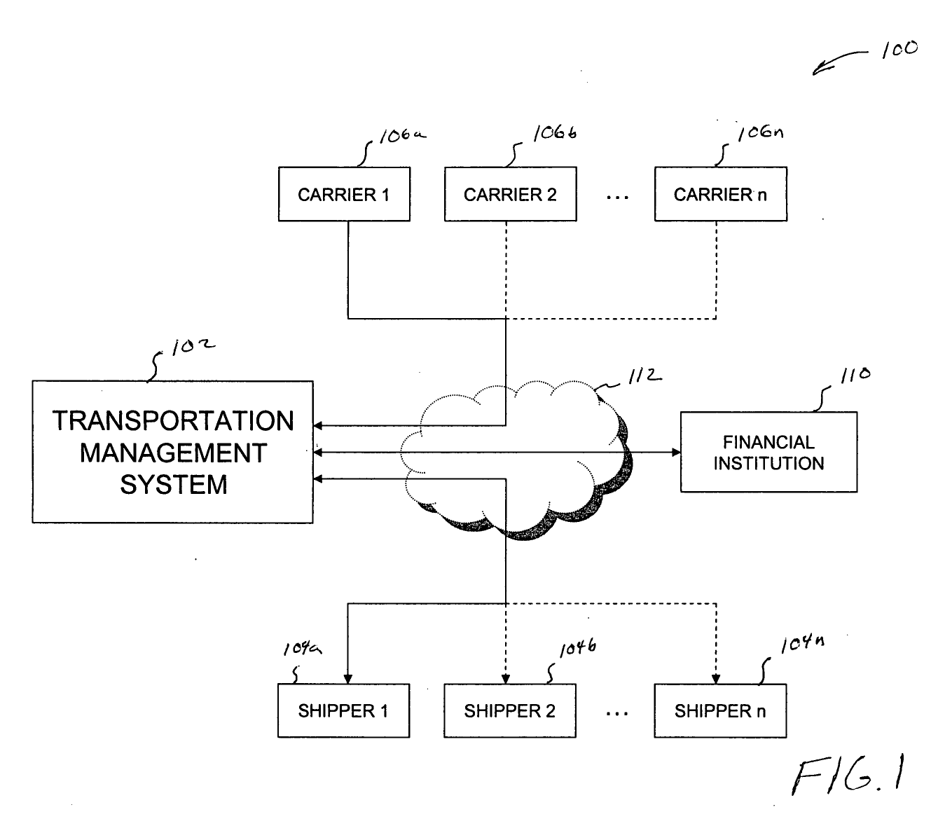

FIG. 1 provides an overview of a transportation system 100 in accordance with the present invention. In general, a transportation management system 102 manages transactions relating to the transportation of goods (e.g., raw materials, manufactured goods, etc.) from one or more shippers 104a-n using one or more carriers 106a-n. As used herein, the term carrier refers to a carrier company having one or more transportation vehicles (not shown) for physically transporting loads of goods from an origin (e.g., a warehouse associated with a shipper) to a destination.

In an exemplary embodiment, a shipper 104 desiring to transport a load of goods transmits information relating to that load to transportation management system 102. Transportation management system 102 tenders (offers) the load to one or more carriers 106 according to automated business rules, described in detail below, and assigns the load to one of the one or more carriers, e.g., carrier 106a. The assigned carrier dispatches a transportation vehicle to an originating location designated by the shipper to transport the load from that location to a destination. Upon confirmation of delivery of the load to the destination, transportation management system 102 instructs a financial institution 108 to pay the carrier. In an exemplary embodiment, communications between transportation management system 102 and shippers 104, carriers 106, and financial institution 108 are performed over a network 112 including one or more local information networks (e.g., intranets) and/or global information networks (e.g., the Internet).

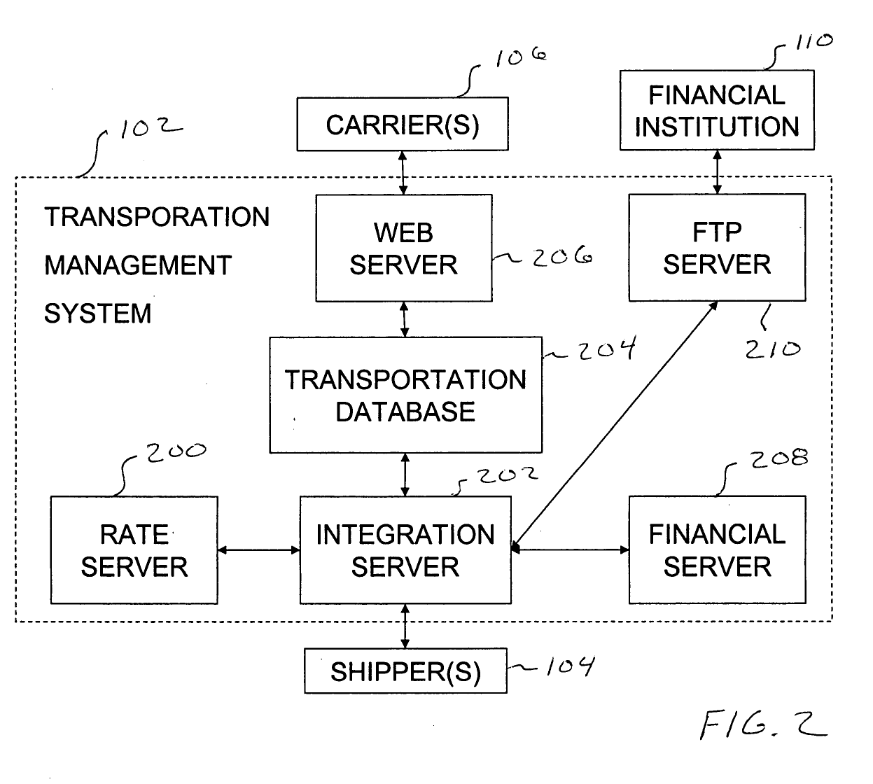

FIG. 2 depicts an exemplary transportation management system 102 for managing transactions associated with the transportation of goods from shipper(s) 104 by carrier(s) 106. Transportation management system 102 includes a rate server 200, an integration server 202, a transportation database 204, a web server 206, a financial server 208, and a file transfer protocol (FTP) server 210.

Rate server 200 houses rate information associated with carriers 106. In an exemplary embodiment, the rate information housed on rate server 200 includes contracted shipping rates between shippers 104 and carriers 106. Different carriers may have different rates and each carrier may have multiple rates, e.g. a location rate, a flat rate, or a mileage rate. Rate server 200 is coupled to integration server 202, which accesses rate server 200 to retrieve rate information needed by transportation management system 102. Information on rate server 200 may be accessed and updated via integration server 202 by personnel associated with transportation management system 102 and shippers 104. In an exemplary embodiment, rate server 200 resides on a computer system capable of processing instructions and storing data as will be understood by those skilled in the art. An example of a suitable computer system (for rate server 200, as well as the other servers described with respect to the present invention) is a Dell PowerEdge 2650™ available from Dell Computer Corporation of Round Rock, Tex., USA.

Integration server 202 develops load information for tending loads to carrier(s) 106. Integration server 202 is coupled to receive load information from shippers 104. In addition, integration server 202 is coupled to rate server 202, transportation database 204, and financial server 208 to exchange data therewith. Integration server 202 is configured to query rate server 200 to obtain carrier specific rate information. Integration server 202 then integrates the load and rate information, applies automated business rules to develop load tender information, and transmits the load tender information to transportation database 204. The automated business rules, described in detail below, are automated rules (many of which are user updateable) that specify how transportation management system 102 performs transportation management tasks from the tendering and acceptance of loads to the payment of carriers 106. The automated business rules can be developed and modified to accommodate the needs of a particular shipper and/or the requirements of a particular type of business. For example, a recycling facility may have different business rules than a garment manufacturer.

In an exemplary embodiment, shippers 102 access integration server 202 via a conventional intranet, e.g., a restricted access network that may include multiple remote locations. In alternative embodiments, shippers 102 access integration server 202 over the Internet via web server 206 in addition to, or instead of, via the intranet. Integration server 202 is a conventional computer system housing a rate information software product, an intranet communication software product, and a business rule software program developed to apply the automated business rules, as described herein. In an exemplary embodiment, the rate information software product calculates mileage between two different points by zip codes and provides rankings and associated ratings of all carriers within the system based on the automated business rules, and the business rule software program uses the rankings and associated ratings and applies additional business rules to develop load tender information for tendering loads to carriers 106.

The development of a suitable business rule software program for applying automated business rules for tendering loads to carriers 106 in accordance with the present invention will be understood to those of skill in the art from the description contained herein of the automated business rules and their application. An example of a suitable rate information software product is FiguRATES™ available from Open Lane Enterprises, Inc., USA, and an example of a suitable intranet communication software product is BizTalk™ available from Microsoft Corporation of Redmond, Wash., USA.

Transportation database 204 houses transportation management information and is coupled to integration server 202 and web server 206. Transportation database 204 is configured to store load tender information received from integration server 202 and make the stored load tender information available to carriers 106 via web server 206. In addition, transportation database 204 is configured for access by shippers 104, e.g., through the Internet via web server 202 or through an intranet. In an exemplary embodiment, transportation management system 102 is configured such that all data flowing between shippers 104 and transportation database 204 passes through integration sever 202.

In an exemplary embodiment, transportation database 204 is a single database that stores transportation management system information. Storing transportation management system information on a single database enables easy retrieval of information, thereby facilitating route planning and other transportation management system functions. An example of a suitable database for use in the present invention is Oracle 9i™ available from Oracle Corporation of Redwood Shores, Calif., USA, or other such database. In an alternative embodiment, transportation database 204 resides on several disbursed databases.

Web server 206 enables access to transportation management system 102 over the Internet. Web server 206 is coupled to carriers 106 and transportation database 204, e.g., through the Internet. The web server 206 can additionally be coupled to shippers 104 and integration server 202 (connections not shown to avoid confusion). In an exemplary embodiment, web server 206 is configured to store carrier and shipper specific markup language files such as hyper text markup language (HTML) files and extensible markup language (XML) files for presenting information from, and writing information to, transportation database 204. The markup language files define web pages with graphical user interfaces (GUIs) for viewing via web browsers running on computer systems/networks at the carriers and shippers, thereby providing a user friendly interface. Examples of such web browsers include Microsoft Internet Explorer™ and Netscape Navigator™. Others methods of providing GUIs for users will be understood by those skilled in the art.

Web pages with GUIs hosted by web server 206 include, by way of non-limiting example: a web page GUI displaying all loads currently tendered to a carrier for presentation to the carrier when the carrier logs onto the system; a web page GUI allowing a carrier to enter the date on which a load was delivered, with the transportation database being updated with the entered information; and a web page GUI enabling the shipper to query the transportation database for loads tendered to carriers by that particular shipper during a specified time period, with the results presented to the shipper in another GUI.

In an exemplary embodiment, web server 206 is configured to notify carriers 106, e.g., visually or aurally, when a tendered load is available for acceptance by that carrier 106, which is described in further detail below. An exemplary web server 206 includes web server software and a transportation management system web software program running on a computer system capable of processing instructions and storing data. The development of suitable transportation management system web software program will be understood by those of skill in the art.

Financial server 208 processes financial information associated with transportation management system 102. Financial server 208 is coupled to integration server 202 and to FTP server 210. The connection to FTP server 210 may be direct or indirect, e.g., through integration server 202. In addition, financial server 208 may be located in a location remote to integration sever 202 and may access the integration server via an FTP server (not shown) residing on the same computer system as integration server 202. An exemplary financial server 208 is a conventional financial service software product running on a conventional computer system. An example of a suitable financial service software product for use in the present invention is Oracle Financials™ available from Oracle Corporation of Redwood Shores, Calif., USA.

Financial server 208 is configured to receive and store payment terms for making payments to carriers 106. Additionally, financial server 208 is configured to instruct financial institution 110, e.g., via integration server 202 and FTP server 210, to make a payment to a carrier or the carrier's financial institution (not shown) in accordance with the stored payment terms. In an exemplary embodiment, financial server 208 is configured to issue an instruction to make a payment in response to a payment instruction from integration server 202, which is responsive to confirmation of delivery of a load by the carrier. In an exemplary embodiment, financial server 208 is further configured to receive payment information from financial institution 110. Payment information from financial institution 110 may include by way of non-limiting example, confirmation of payment instructions from transportation management system 102 and payments made to carriers 106 upon satisfactory completion of payment terms.

FTP server 210 enables communication between transportation management system 102 and financial institution 110. FTP server 210 is coupled to integration server 202, financial server 208, and financial institution 110. An exemplary FTP server 210 is a conventional computer system running conventional FTP software.

In an exemplary embodiment, all communications between transportation management system 102 and carriers 106 and financial institution 110 are through a firewall (not shown). The firewall can be implemented using a dedicated conventional computer running conventional firewall software. In an exemplary embodiment, all communications traveling between web server 206 and shippers 104 and carriers 106 and between FTP server 210 and financial institution 110 pass through the firewall.

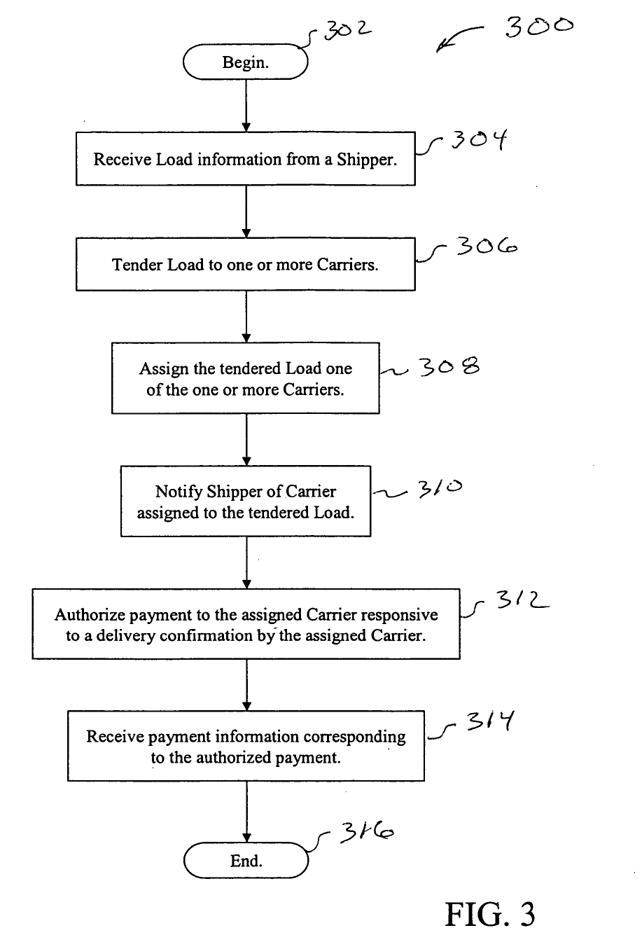

FIG. 3 is a flow chart 300 depicting steps for managing the transportation of a load of goods in accordance with an exemplary embodiment of the present invention. Processing of the load begins at block 302 with the receipt of load information through an electronic interface from a shipper at transportation management system 102 at block 304. The load information includes information about a load of goods, e.g., the type of goods, the weight of the goods, a pickup date, a delivery data, a pickup location, and a delivery location.

In an exemplary embodiment, the shipper enters the load information into a processing system located at the shipper. In accordance with this embodiment, the processing system generates a load information file containing the load information and transmits the load information file to transportation management system 102, e.g., via a flat file communicated in a known manner. In an alternative embodiment, the shipper provides the load information directly to transportation management system 102 via a network interface such as a GUI presented over the Internet. In an exemplary embodiment, load information from the shippers is received at integration server 104 (FIG. 2) and loaded using an intranet communication software product that creates a load tendering (LT) record in the transportation database.

At block 306, transportation management system 102 tenders the load to one or more carriers based on automated business rules. The business rules dictate how many carriers the load is tendered to and how much time each carrier receives to accept/decline the tendered load before the load is tendered on to the next carrier. In an exemplary embodiment, the load is tendered to the carriers one at a time. For example, the load is offered to a first carrier and if the first carrier does not accept the load within a predetermined time limit, the load is tendered to a second carrier, etc. In an alternative embodiment, the loads are tendered to multiple carriers concurrently. In this alternative embodiment, the multiple carriers may bid on the load.

In an exemplary embodiment, the shipper defines the automated business rules. The business rules can be assigned based on a particular location or a particular shipping lane. A location rule governs the tendering of goods from a particular location, e.g., the shippers warehouse. A shipping lane rule governs the tendering of goods between a particular origin and destination, e.g., from Atlanta, Ga. to Chicago, Ill. The business rules specify, by way of non-limiting example, a sort order, a use routing option, a time out period, a maximum number of carriers for tendering, a number of days in advance to tender loads, roll over options, a number of accounts payable hold days, a tender approval option, and a location id for products for purchase for resale. In an exemplary embodiment, the shippers set the business rules using a GUI displayed at the shipper.

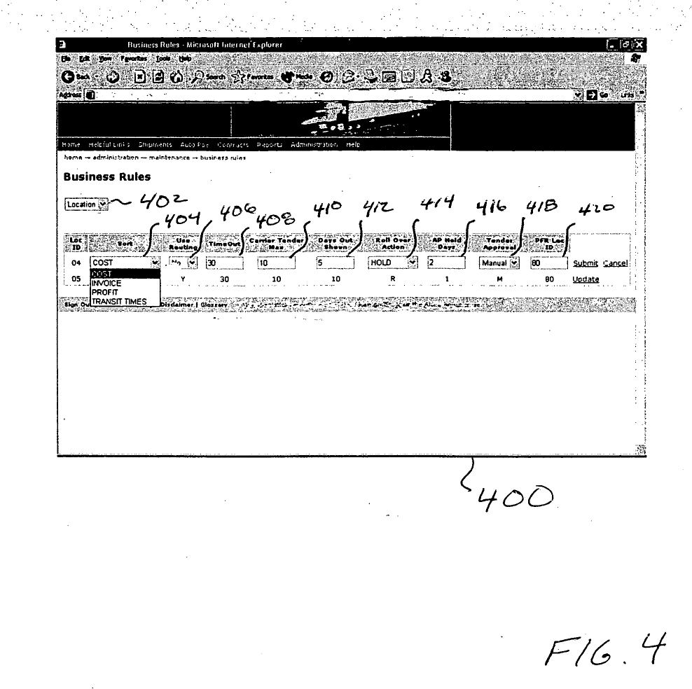

FIG. 4 depicts a screen display of an exemplary business rules GUI 400 for use by shippers to set the business rules. GUI 400 includes a location/lane user selection box 402, a sort order selection box 404, a use routing selection box 406, a time out period input box 408, a maximum carrier tender input box 410, a days out input box 412, a roll over action selection box 414, an accounts payable hold days input box 416, a tender approval selection box 418, and a product for resale (PFR) input box 420. Using the selection/input boxes, users select/enter business rule preferences for use by transportation management system 102. In an exemplary embodiment, the user selects either location or lane in a conventional manner from a drop down menu (not shown) associated with location/lane user selection box 410 to specify business rules by location or by shipping lane, respectively.

A sort order identified in sort order selection box 402 specifies the order in which loads are tendered to the carriers. The sort order parameters may include total carrier cost, carrier invoice cost, or carrier transit times. The user may select one of the sort order parameters from a drop down menu 422 associated with sort order selection box 402. In an exemplary embodiment, the selection of the sort order results in the generation of an electronic mode indicator corresponding to the selected sort parameter for receipt by the transportation management system 102, which tenders the load to carriers responsive to the mode indicator.

Integration server 202 (FIG. 2) retrieves rate information or transit time (depending on the specified sort order) for a carrier from rate server 200 (FIG. 2) and processes the rate or transit information and load information to determine the order in which to tender the goods to the carriers based on the business rules, e.g., using the FiguRATES™ software product and the business rules software program. The rate information may include, among others, a mileage rate, flat rate, weight rate, accessorial rate, surcharge rate, and tax rate. In an exemplary embodiment, the FiguRATES™ software application determines the sort order based on the sort order specified by the shipper and the transportation management software application implements the remaining automated business rules to develop a FiguRATES™ carrier (FC) table. The FC table includes ranking and rates for each carrier available for a shipment, e.g., carriers having the correct equipment type, located in correct geographical area, etc. The LT and FC tables are processed to identify the carrier order in which a shipment should be tendered to the carriers. A primary carrier may be designated for a location or a shipping lane. If designated, the tendered load for the location or shipping lane is always offered to the primary carrier first regardless of cost or transit times and then is offered to other carriers based on the sort order.

A use routing option identified using the use routing selection box 406 allows a primary carrier to be set for a lane. When the use routing option is turned on, the load is tendered to the primary carrier regardless of rate and, then, to other carriers based on the automated business rules. When the use routing option is turned off, the load is tendered based on the automated business rules. In an alternative embodiment, a specified carrier can be selected manually when the use routing option is turned off.

A time out period entered in time out period input box 408 represents the period of time, e.g., number of minutes, that a load is tendered to a carrier before being offered to another carrier. For example, if the load is tendered to the carriers one at a time and the time out period is set to 30 minutes, the load is tendered to a first carrier for 30 minutes. If the first carrier does not accept the tendered load within 30 minutes, the tendered load is withdrawn from the first carrier and tendered to a second carrier for 30 minutes, etc. The user can enter the time out period directly into time out period input box 408 using conventional techniques.

A carrier tender maximum entered in maximum carrier tender input box 410 specifies the maximum number of carriers to which a load is tendered. For example, if there are 50 carriers, the cost sort order is selected, and the carrier tender maximum is set to ten, the load is tendered to the ten lowest cost carriers (or the primary carrier and the nine lowest cost carriers if a primary carrier is specified for use for a lane). A days out shown entered in days out input box 412 specifies the number of days that a load is tendered to the carriers prior to the load pickup date. For example, if the load pickup date is the tenth of a particular month and the days out shown is five days, the load is tendered to a carrier on the fifth of that month.

A roll over action identified in roll over action selection box 414 specifies what happens after the load is tendered to all carriers to which the load is to be tendered and none of the carriers accept the load. The roll over action can be set to restart, hold, and assign. When set to restart, after tendering the load to all of the specified maximum number of carriers, the load is tendered to the carriers again starting with the first carrier. In an exemplary embodiment, the load is only tendered to carriers that did not initially decline the tendered load. In an alternative embodiment, the load is tendered to all carriers again regardless of whether they initially declined the tendered load. When set to hold, the load is manually tendered after it has been tendered to all of the specified maximum number of carriers. When set to assign, the load is assigned to the first carrier without the option to decline after tendering the load to all of the specified maximum number of carriers.

An AP hold days entered in AP hold days input box 416 specifies the number of days that a payment is held before being sent to accounts payable, e.g., financial server 208.

A tender approval option identified in tender approval selection box 418 includes a manual setting and an automatic setting. When set for manual approval, the order in which the load is tendered to the carriers is first manually approved. When set to automatic approval, the order in which the load is tendered to the carriers is automatically approved.

A PFR identifier entered in PFR input box 420 specifies a location id for association with the load for products for purchase for resale.

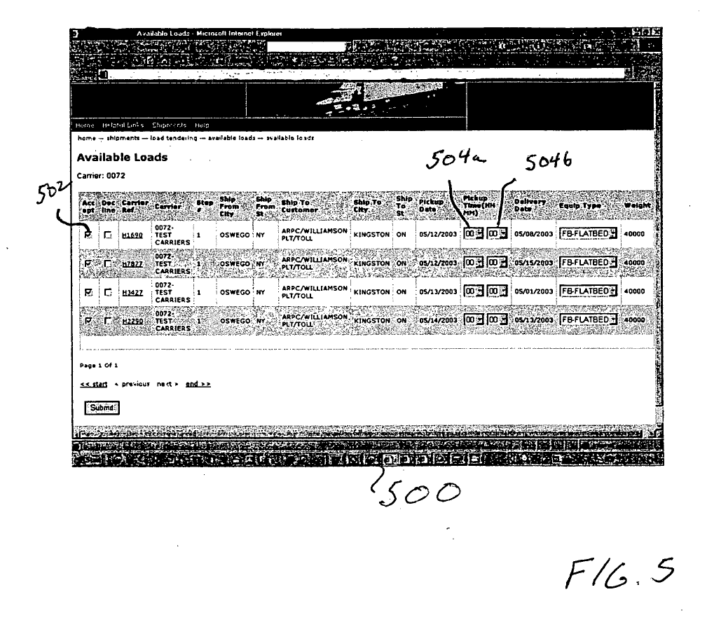

FIG. 5 depicts a screen display of an exemplary tender GUI 500 for tendering loads to a carrier. The GUI 500 presents a carrier reference number, carrier identifier, number of stops, ship from city and state, ship to customer (address, city, and state), pickup date, delivery date, and shipment weight. In addition, carrier input boxes (e.g., accept check box 502 and pickup time selection boxes 504a and 504b) are provided to allow the carrier to accept or decline the tendered load, specify a pickup time, and display to the carrier the equipment type necessary to pick up the tendered load (e.g., flatbed, semi-tractor trailer, refrigerated, etc.). In an exemplary embodiment, a carrier either accepts or declines the tendered load. If the carrier accepts the load, an electronic accept indicator is generated for receipt at transportation management system 102 and the load is not tendered to additional carriers. If the carrier declines the load (e.g., if the carrier doesn't have an available transportation vehicle) or the time out period elapses, the load is tendered to the next carrier. Declining the load results in the generation of an electronic decline indicator for receipt at transportation management system 102. If the time out period elapses, the transportation management system 102 generates and records a time out period indicator associated with the carrier that allowed the time out period to elapse without accepting or declining the load.

In an exemplary embodiment, when a carrier accesses transportation management system 102, the carrier is presented with a GUI (not shown) that lists outstanding transactions needing attention by the carrier. By way of non-limiting example, the list may include available loads and loads requiring confirmation. When logged into the system, the carrier receives an indicator indicating to the carrier that a new load has been tendered to that carrier for acceptance. For example, if a carrier is logged into transportation management system 102, a pop-up window or noise may be generated for presentation at the carrier when tendered loads are available for that carrier. The pop-up window and noise provide notice to the carrier that newly tendered loads are currently available to accept or decline, thereby prompting examination of the tendered loads.

Once a load is accepted it must be confirmed, e.g., via another GUI. Requiring confirmation of the accepted loads adds an additional check to ensure that the carrier is aware of the load and the terms surrounding the load. In an exemplary embodiment, a load confirmation page is displayed in response to confirmation by the carrier. The load confirmation page can be formatted to facilitate printing by the carrier for the carrier's records.

Referring back to FIG. 3, at block 308, transportation management system 102 assigns the tendered load to one of the one or more carriers. In an exemplary embodiment, the tendered load is assigned to a carrier that accepts the load, e.g., responsive to receipt of an electronic accept indicator indicating acceptance at transportation management system 102 (FIG. 2) through a GUI. In an exemplary embodiment, when the carrier accepts the load an electronic accept indicator is generated for receipt at transportation management system 102. When the electronic accept indicator is received, a shipment rate (SR) record is created in transportation database 204 responsive to the received electronic accept indicator. In an alternative embodiment, where the goods are tendered to multiple carriers concurrently, the tendered load may be assigned to a carrier that submits a lowest bid for the tendered load to transportation management system 102 (FIG. 2) or to the first carrier that responds.

At block 310, transportation management system 102 transmits assigned carrier and tendered load information to the shipper corresponding to the tendered load. In an exemplary embodiment, the creation of the SR record (see description of block 308) triggers the intranet communication software product, e.g., the BizTalk™ software, to prompt the integration server 202 to send information corresponding to the shipment back to the shipper that submitted the load for tendering. This information may include the accepting carrier identification number, carrier name, contact information, indicated pickup times, etc. In an exemplary embodiment, the carrier identification number is the carrier's standard carrier alpha code (SCAC) and the assigned carrier and tendered load information is sufficient to generate a bill of lading (BOL).

Transportation management system 102 receives an electronic release signal from the shipper of a load when a carrier assigned to that load picks the load up from the shipper. The shipper generates a BOL when a transportation vehicle associated with the carrier arrives at a source location identified by the shipper. In an exemplary embodiment, the electronic release signal is generated at the shipper when the shipper prints the BOL. BOL information is transferred to transportation management system 102 to enable the creation of a BOL record in transportation database 204. In an alternative embodiment, the shipment information can be entered into the transportation management system 102 and the BOL can be printed from this system.

A final rate is calculated, e.g., by the FiguRATES™ software, responsive to the generation of the BOL record. The SR record is then updated to include the calculated final rates. In addition, an accounts payable (AP) record is created indicating that the load has been picked up. In an exemplary embodiment, when created, the AP record will have a status indicating that payment should not be made, e.g., an “on hold” status.

At block 312, transportation management system 102 authorizes payment to the assigned carrier responsive to an electronic delivery confirmation signal from the assigned carrier. In an exemplary embodiment, the carrier confirms delivery of the load over the Internet. In accordance with this embodiment, the carrier enters load identification information such as the BOL identification number and the actual ship date of the load into a GUI (not shown) displayed on a conventional web browser at the carrier. Entering the load identification information and transmitting it to transportation management system 102 causes the GUI to display the load information, e.g., origin, destination, and destination address. In addition, a text entry box is displayed in which the carrier can enter the actual delivery date of the load. The carrier then submits the actual delivery date in order to generate the electronic delivery confirmation signal to confirm delivery, which is received by transportation management system 102. Alternatively, deliveries are confirmed using traditional electronic data exchange (EDI, for example a “214” delivery receipt transaction) or a structured file received from the carrier. In an alternative embodiment, an entity corresponding to the destination may confirm delivery. If the load has multiple stops, a confirmation may be required and entered for each stop. In an exemplary embodiment, transportation management system 102 only accepts an electronic delivery confirmation signal from the assigned carrier if an electronic release signal is previously received from the shipper of the load.

In an exemplary embodiment, the shippers set the payment terms for the carriers, e.g., via a GUI (not shown) displayed at the shipper. The payment terms may be conventional payment terms such as immediately payable upon delivery, due 15 days from delivery, 2 percent discount if paid in 15 days, etc.

Confirmation of delivery by the carrier initiates an automatic payment process. In an exemplary embodiment, BOL records in transportation management system 102 are updated responsive to the electronic delivery confirmation signal. The AP record is then updated to permit payment, e.g., a status change from “on hold” to “cleared for payment.” Updating the AP record causes transportation management system 102 to send payment authorization to financial server 208. Financial server 208 in turn instructs financial institution 110 to initiate payment to the carrier based on the payment terms by sending a check to the carrier or by transferring payment to a financial institution associated with the carrier. The AP records are then updated to reflect payment and a paid freight (FR) record is generated.

At block 314, transportation management system 102 receives payment information corresponding to the payment authorized at block 312, e.g., from financial institution 110. In an exemplary embodiment, the payment information includes an automated electronic confirmation from financial server 208 confirming receipt of the payment authorization, an automated electronic notification from financial server 208 indicating the transmission of the electronic transaction to financial institution 110, and an electronic notification from financial server 208 indicating the transmission of the electronic transaction to financial institution 110. The payment information corresponding to the payment authorization is stored in transportation database 204.

Processing of the load of goods ends at block 316. In an exemplary embodiment, transportation transaction reports are generated responsive to queries for information stored in transportation database 204 during the processing of the load (i.e., from receipt of load information from a shipper to payment of the carrier and the subsequent confirmation). For example, transportation management system 102 records whether loads tendered to a particular carrier are accepted, declined, or allowed to rollover. In accordance with this example, a particular carrier having an unusually large number of declined shipments or rollovers do to inaction may be identified for corrective action, e.g., discussion with the carrier, performance improvement plans, or termination of the carrier. In an exemplary embodiment, the reports are generated using a conventional report generating tool such as reporting tools available from Cognos Corporation of Burlington, Mass., USA.

In an exemplary embodiment, a carrier may view pending and completed payment reports. When viewing a pending payment report, the carrier is provided with an online report of pending payments. Once a payment is acknowledged, it is removed from the pending payments report. The pending payment report includes an invoice number and date, BOL id, actual delivery date, and payment amount and terms. When viewing a completed payment report, the carrier is provided with an online report of payments paid for a previously solicited date range. In an exemplary embodiment, the completed payment report includes an invoice number and date, a paid date, a BOL id, and the payment amount and terms.

In an exemplary embodiment, the carrier and/or a user of transportation management system 102 can initiate, change, and track payment disputes. For example, disputes can be initiated on loads that have already been shipped. In addition, the carrier and/or the user can look up unresolved and resolved disputes.

In an exemplary embodiment, disputes are initiated by entering the BOL id, ship date, and a carrier identification number using a GUI (not shown). Once the information is entered, the original amount paid or to be paid along with the BOL id, ship date, location id, and carrier identification number is displayed in another GUI. In addition, fields are present to receive dispute information, e.g., the amount underpaid or overpaid. Upon approval, if an amount is entered in an underpaid field, an accounts payable transaction is generated automatically by transportation management system 102 (FIG. 2) responsive to the approval and, if an amount is entered in the overpaid field, a credit is issued automatically to the carrier by transportation management system 102 (FIG. 2) responsive to the approval. In an exemplary embodiment, a comment is required in addition to the disputed amount and the dispute is not initiated until a comment is entered.

When a dispute is initiated by a party, e.g., a carrier, an e-mail is automatically generated responsive to the initiated dispute to another party, e.g., a shipper or the host of transportation management system 102. The other party may then respond to the initiated dispute.

To look up a dispute, a carrier or other party enters a dispute type, e.g., open, pay, or deny. Selecting one of the dispute types results in the display of all disputes of that particular type for the carrier. The user may then access the disputes to determine the status of the dispute, review comments from another party, and/or add additional comments.

In an exemplary embodiment, automated scales are located at the shippers. The automated scales feed transportation management system 102 the weight of incoming and outgoing transportation vehicles to generate an actual weight for the load. Transportation management system 102 then compares the actual weight to a weight value for the load that was previously entered by the shipper. If the difference between the actual weight and the entered weight exceed a predefined value, an indicator is automatically generated responsive to the calculated difference. In an exemplary embodiment, the indicator is transmitted to the shipper and or the host of transportation management system 102 for further investigation.

In an exemplary embodiment, transportation vehicles are monitored automatically in the vicinity of the shippers, e.g., using sensors attached to the vehicles or global positioning systems (GPS), to efficiently move the vehicles into loading docks. For example, if a loading dock is not ready for a transportation vehicle, the transportation vehicle may be directed to a series of staging lots. When directed to a staging lot, a conventional transmitter or transceiver may be attached to the vehicle so that the location of the vehicle may be monitored using a conventional receiver or transceiver and the transportation vehicle may be directed to different staging lots until the loading dock is ready to receive the transportation vehicle. The transmitter may then be removed once the transportation vehicle is in the loading dock.

In an exemplary embodiment, payments can be suspended to prevent automatic payment at the scheduled time in response to an electronic hold payment indicator. In this exemplary embodiment, a shipper or personnel associated with the transportation management submits a BOL number to transportation management system 102, e.g., via a payment hold GUI. Transportation management system 102 then suspends payment for the load corresponding to that BOL number responsive to the receipt of the BOL number. In one embodiment, payment is suspended indefinitely until the hold is manually released. In other embodiments, the hold is released automatically after a predefined period of time, e.g., 5 days, which may be specified by the shipper or personnel placing the BOL on hold.

Although the components of the present invention have been described in terms of specific components, it is contemplated that one or more of the components may be implemented in software running on general purpose or specialty computers. In this embodiment, one or more of the functions of the various components may be implemented in software that controls the general purpose computers. This software may be embodied in a computer readable carrier, for example, a magnetic or optical disk, a memory-card or an audio frequency, radio-frequency or optical carrier wave. The software may also be wholly or partially embedded in a memory or integrated circuit.

Although the invention is illustrated and described herein with reference to specific embodiments, the invention is not intended to be limited to the details shown. Rather, various modifications may be made in the details within the scope and range of equivalents of the claims and without departing from the invention.

1. An integrated transportation method for use between one or more shippers and a plurality of carriers, the method comprising the steps of:
receiving load information corresponding to a load from a shipper through an electronic interface;
tendering the load to one or more carriers over a global information network according to automated business rules;
assigning one of the one or more carriers to the tendered load;
notifying the shipper of the assigned carrier for the tendered load through the electronic interface;
receiving an electronic delivery confirmation signal corresponding to the tendered load from the assigned carrier;
authorizing payment to the assigned carrier responsive to the electronic delivery confirmation signal; and
receiving payment information corresponding to the authorized payment.

2. The method of claim 1, further comprising the step of:
receiving an electronic release signal from the shipper indicating release of the tendered load to the assigned carrier through the electronic interface; and
the authorizing payment step comprises authorizing payment to the assigned carrier responsive to the electronic release signal and the electronic delivery confirmation signal only if the electronic delivery confirmation signal is received after receiving the electronic release signal.

3. The method of claim 2, wherein the step of notifying the shipper comprises the step of:
transmitting to the shipper assigned carrier and tendered load information necessary to generate and print a bill of lading at the shipper, wherein the electronic release signal from the shipper indicating release of the tendered load to the assigned carrier is generated in response to printing the bill of lading.

4. The method of claim 1, wherein the one or more carriers includes two or more carriers and the tendering step comprises the step of:
receiving an electronic mode indicator corresponding to one of a straight tender mode, a sequential tender mode, and a sequential rollover tender mode for tendering the load to the two or more carriers; and
tendering the load to the two or more carriers responsive to the mode indicator.

5. The method of claim 1, wherein the tendering step comprises the step of:
tendering the load to the one or more carriers according to the automated business rules, the automated business rules including a sort order parameters selected from a set of available sort order parameters by a user, the set of available sort order parameters including tendering the load to a primary carrier for the load, tendering the load to at least one lowest cost carrier for the load, and tendering the load to at least one shortest transit time carrier for the load.

6. The method of 1, wherein the step of tendering the load comprises the steps of:
a) tendering the load to a first one of the one or more carriers;
b) tendering the load to a subsequent one of the one or more carriers responsive to an electronic decline indicator from the carrier to which the load is currently being tendered or inaction for a predetermined period of time by the carrier to which the load is currently being tendered; and
c) repeating step (b) until an electronic accept indicator is received from the carrier to which the load is currently being tendered.

7. The method of claim 6, further comprising the step of:
tracking inaction by the carrier to which the load is currently being tendered.

8. The method of claim 1, wherein the step of tendering the load comprises the step of:
tendering the load to a plurality of the one or more carriers concurrently.

9. The method of claim 1, wherein the step of assigning one of the one or more carriers to the tendered load includes the steps of:
receiving an electronic accept indicator from the one of the one or more carriers; and
assigning the assigned carrier responsive to the received electronic accept indicator.

10. The method of claim 1, wherein the authorization of payment to the assigned carrier is made to a financial server that transmits an electronic transaction to a financial institution and wherein the step of receiving payment information comprises the steps of:
receiving automated electronic confirmation from the financial server confirming receipt of the payment authorization;
receiving automated electronic notification from the financial server indicating the transmission of the electronic transaction to the financial institution; and
receiving electronic notification of payment to the assigned carrier from the financial institution.

11. The method of claim 1, wherein the step of authorizing payment includes the step of:
electronically authorizing payment responsive to the electronic delivery confirmation signal and to payment terms contracted with the assigned carrier.

12. The method of claim 1, further comprising the step of:
storing the load information, the payment information, and information corresponding to the tendering step in a central database.

13. The method of claim 12, further comprising the steps of:
querying the central database to obtain information from one or more of the load information, the payment information, and the information corresponding to the tendering step; and
generating a transportation transaction report responsive to the query.

14. The method of claim 1, further comprising the steps of:
receiving an electronic hold payment indicator; and
suspending the step of authorizing payment responsive to receipt of the electronic hold payment indicator.

15. An integrated transportation method for use between one or more shippers and a plurality of carriers, the method comprising the steps of:
receiving load information corresponding to a load from a shipper through an electronic interface;
tendering the load to one or more carriers over a global information network according to automated business rules;
assigning one of the one or more carriers to the tendered load;
notifying the shipper of the assigned carrier for the tendered load through the electronic interface;
receiving through the electronic interface an electronic release signal from the shipper indicating release of the tendered load to the assigned carrier;
receiving an electronic delivery confirmation signal from the assigned carrier confirming delivery of the load;
authorizing payment to the assigned carrier responsive to the electronic release signal and the electronic delivery confirmation signal, wherein payment is authorized only if the electronic delivery confirmation signal is received after receiving the electronic release signal; and
receiving payment information corresponding to the authorized payment.

16. The method of claim 15, wherein the one or more carriers includes two or more carriers and the tendering step comprises the step of:
receiving an electronic mode indicator corresponding to one of a straight tender mode, a sequential tender mode, and a sequential rollover tender mode for tendering the load to the two or more carriers; and
tendering the load to the two or more carriers responsive to the mode indicator.

17. The method of claim 15, wherein the tendering step comprises the step of:
tendering the load to the one or more carriers according to the automated business rules, the automated business rules including a sort order parameters selected from a set of available sort order parameters by a user, the set of available sort order parameters including tendering the load to a primary carrier for the load, tendering the load to at least one lowest cost carrier for the load, and tendering the load to at least one shortest transit time carrier for the load.

18. The method of 15, wherein the step of tendering the load comprises the steps of:
a) tendering the load to a first one of the one or more carriers at a time;
b) tendering the load to a subsequent one of the one or more carriers responsive to an electronic decline indicator from the carrier to which the load is currently being tendered or inaction for a predetermined period of time by the carrier to which the load is currently being tendered; and
c) repeating step (b) until an electronic accept indicator is received from the carrier to which the load is currently being tendered.

19. The method of claim 15, wherein the step of notifying the shipper comprises the step of:
transmitting to the shipper assigned carrier and tendered load information necessary to generate and print a bill of lading at the shipper, wherein the indicator from the shipper indicating release of the tendered load to the assigned carrier is generated in response to printing the bill of lading.

20. The method of claim 15, further comprising the step of:
storing the load information, the payment information, and information corresponding to the tendering step in a central database.

21. An integrated transportation system for use between one or more shippers and a plurality of carriers, the system comprising:
means for receiving load information corresponding to a load from a shipper through an electronic interface;
means for tendering the load to one or more carriers over a global information network using automated business rules;
means for assigning one of the one or more carriers to the tendered load;
means for notifying the shipper of the assigned carrier for the tendered load through the electronic interface;
means for receiving an electronic delivery confirmation signal corresponding to the tendered load from the assigned carrier;
means for authorizing payment to the assigned carrier responsive to the electronic delivery confirmation signal; and
means for receiving payment information corresponding to the authorized payment.

22. The system of claim 21, further comprising:
means for receiving an electronic release signal from the shipper indicating release of the tendered load to the assigned carrier through the electronic interface; and
the means for authorizing payment comprising means for authorizing payment to the assigned carrier responsive to the electronic release signal and the electronic delivery confirmation signal only if the electronic delivery confirmation signal is received after receiving the electronic release signal.

23. The system of claim 22, wherein the notifying means comprises:
means for transmitting to the shipper assigned carrier and tendered load information necessary to generate and print a bill of lading at the shipper, wherein the electronic release signal from the shipper indicating release of the tendered load to the assigned carrier is generated in response to printing the bill of lading.

24. The system of claim 21, wherein the one or more carriers includes two or more carriers and the tendering means comprises:
means for receiving an electronic mode indicator corresponding to one of a straight tender mode, a sequential tender mode, and a sequential rollover tender mode for tendering the load to the two or more carriers; and
means for tendering the load to the two or more carriers responsive to the mode indicator.

25. The system of claim 21, wherein the tendering means comprises:
means for tendering the load to the one or more carriers according to the automated business rules, the automated business rules including a sort order parameters selected from a set of available sort order parameters by a user, the set of available sort order parameters including tendering the load to a primary carrier for the load, tendering the load to at least one lowest cost carrier for the load, and tendering the load to at least one shortest transit time carrier for the load.

26. The system of claims 21, wherein the tendering means comprises:
means for tendering the load to a first one of the one or more carriers;
means for tendering the load to a subsequent one of the one or more carriers responsive to an electronic decline indicator from the carrier to which the load is currently being tendered or inaction for a predetermined period of time by the carrier to which the load is currently being tendered; and
means for repeating the tendering of loads to subsequent ones of the one or more carriers until an electronic accept indicator is received from the carrier to which the load is currently being tendered.

27. The system of claim 26, further comprising:
means for tracking inaction by the carrier to which the load is currently being tendered.

28. The system of claim 26, wherein the tendering means comprises:
means for tendering the load to a plurality of the one or more carriers concurrently.

29. The system of claim 21, wherein means for assigning one of the one or more carriers to the tendered load includes:
means for receiving an electronic accept indicator from the one of the one or more carriers; and
means for assigning the assigned carrier responsive to the received electronic accept indicator.

30. The system of claim 21, wherein the authorization of payment to the assigned carrier is made to a financial server that transmits an electronic transaction to a financial institution and wherein the means for receiving payment information comprises:
means for receiving automated electronic confirmation from the financial server confirming receipt of the payment authorization;
means for receiving automated electronic notification from the financial server indicating the transmission of the electronic transaction to the financial institution; and
means for receiving electronic notification of payment to the assigned carrier from the financial institution.

31. The system of claim 21, wherein the means for authorizing payment includes:
means for electronically authorizing payment responsive to the electronic delivery confirmation signal and to payment terms contracted with the assigned carrier.

32. The system of claim 21, further comprising:
means for storing the load information, the payment information, and information corresponding to the tendering step in a central database.

33. The system of claim 32, further comprising:
means for querying the central database to obtain information from one or more of the load information, the payment information, and the information corresponding to the tendering step; and
means for generating a transportation transaction report responsive to the query.

34. The system of claim 21, further comprising:
means for receiving an electronic hold payment indicator; and
means for suspending the step of authorizing payment responsive to receipt of the electronic hold payment indicator.

35. A computer readable carrier including software that is configured to control general purpose computers to implement an integrated transportation method for use between one or more shippers and a plurality of carriers, the method comprising the steps of:
receiving load information corresponding to a load from a shipper through an electronic interface;
tendering the load to one or more carriers over a global information network using automated business rules;
assigning one of the one or more carriers to the tendered load;
notifying the shipper of the assigned carrier for the tendered load through the electronic interface;
receiving an electronic delivery confirmation signal corresponding to the tendered load from the assigned carrier;
authorizing payment to the assigned carrier responsive to the electronic delivery confirmation signal; and
receiving payment information corresponding to the authorized payment.

36. The computer readable carrier of claim 35, wherein the software implemented method further comprises the step of:
receiving an electronic release signal from the shipper indicating release of the tendered load to the assigned carrier through the electronic interface; and
the step of authorizing payment comprising the step of authorizing payment to the assigned carrier responsive to the electronic release signal and the electronic delivery confirmation signal only if the electronic delivery confirmation signal is received after receiving the electronic release signal.

37. The computer readable carrier of claim 35, wherein the software implemented method further comprises the step of:
tracking inaction by the carrier to which the load is currently being tendered.

38. The computer readable carrier of claim 35, wherein the software implemented method further comprises the step of:
storing the load information, the payment information, and information corresponding to the tendering step in a central database.

39. The computer readable carrier of claim 38, wherein the software implemented method further comprises the step of:
querying the central database to obtain information from one or more of the load information, the payment information, and the information corresponding to the tendering step; and
generating a transportation transaction report responsive to the query.

40. The computer readable carrier of claim 35, wherein the software implemented method further comprises the step of:
receiving an electronic hold payment indicator; and
suspending the step of authorizing payment responsive to receipt of the electronic hold payment indicator.

41. An integrated transportation apparatus for use between one or more shippers and a plurality of carriers, the apparatus comprising:
a rate server including rate information for each of the plurality of carriers;
an integration server coupled to the rate server and in communication with the one or more shippers, the integration server configured to integrate load information for a load received from the one or more shippers and rate information received from the rate server to generate load tender information for the load according to automated business rules;
a transportation database accessible by the integration server and the plurality of carriers, the transportation database configured to receive and store the load tendering information from the integration server for tendering the load to one or more of the plurality of carriers according to the automated business rules; and
a financial server coupled to the integration server, the financial server configured to authorize a financial institution to pay one of the plurality of carriers upon confirmation of delivery of the load.

42. The apparatus of claims 41, further comprising:
a web server coupled to the transportation database to enable communication with the plurality of carriers over a global information network.

43. The apparatus of claim 41, further comprising:
an FTP server coupled to the financial server to enable communication with the financial institution.
